(19) United States
(12) Patent Application Publication
(10) Pub. No.: US 2006/0218752 A1
(43) Pub. Date: Oct. 5, 2006

(54) Collet locks and extension pole assemblies comprising same

(76) Inventor: Michael M. Potempa, Oak Creek, WI (US)

Correspondence Address: TAFT, STETTINIUS & HOLLISTER LLP, SUITE 1800, 425 WALNUT STREET, CINCINNATI, OH, 45202-3957, US

(21) Appl. No.: 11/184,105

(22) Filed: Jul. 19, 2005

Related U.S. Application Data
(60) Provisional application No. 60/667,187, filed on Mar. 30, 2005.

(51) Int. Cl. B25G 1/04

(52) U.S. Cl. 16/429

(57) ABSTRACT

A rotatable handle for use with a collet in a wet environment includes a body with an internal passage extending therethrough. The internal passage is at least partially threaded and the body is disposable on a threaded collet base. Upon rotation of the body relative to the threaded collet base, the body can selectively engage a collet such that the collet engages a tube, thereby selectively locating the tube. The body has a longitudinal axis along the passage, a major axis perpendicular to the longitudinal axis, and a minor axis perpendicular to the major axis. The body has a first length along the major axis and a second length along the minor axis, and the first length is longer than the second length.

### CROSS REFERENCE TO RELATED APPLICATION

This application claims priority to U.S. Provisional Application No. 60/667,187, filed on Mar. 30, 2005.

### FIELD OF THE INVENTION

The invention relates generally to a locking mechanism for an extension pole.

### BACKGROUND OF THE INVENTION

Tools are often disposed on the end of poles so as to increase the range at which the tool can be implemented. For example, in the painting industry, a painter can place a paint applicator on the end of a pole so that he or she can paint areas at a distance higher than could normally be reached.

The length of some extension poles can be increased or decreased to provide a specific desired length. The pole can be extended to reach high locations, and then retracted for easy storage. Extension poles can be constructed of an inner tube disposed in and sliding relative to an outer tube. To lengthen the extension pole, the user pulls the inner tube out of the outer tube to the desired location and locks the inner tube relative to the outer tube.

One mechanism for locking the inner tube relative to the outer tube is a collet lock. Once the inner tube is placed in the proper location, the collet lock handle is rotated relative to the outer tube to lock the inner tube in place. To release the inner tube, the collet lock handle is rotated in the opposite direction. The collet lock handle generally has a cylindrical configuration.

One of the drawbacks of the cylindrical collet lock is that it can be difficult to rotate the collet lock sufficiently so as to lock the inner tube. This drawback is exacerbated when the extension pole is used in an environment that is wet, slippery or both.

In one attempt to address this problem, ribs have been added to an outside surface of the collet lock handle. While this has made it easier to grasp (and thus rotate) the collet lock handle, the ribs tend to dig into the user's hands and are uncomfortable, particularly after extended use. Another example of an attempt to address the problem includes the addition of an overmold material with a higher coefficient of friction such that the collet handle is easier to grip.

### BRIEF DESCRIPTION OF THE DRAWINGS

FIG. 1 is a perspective view of an extension pole including a collet lock in accordance with the disclosure in a collapsed state.

FIG. 2 is an exploded view of the extension pole of FIG. 1

FIG. 3 is a cross-sectional view of the extension pole of FIG. 1 taken along line III-III.

FIG. 3A is an enlarged view of the front end of the extension pole as shown in FIG. 3.

FIG. 3B is an enlarged view of the rear end of the extension pole as shown in FIG. 3.

FIG. 4 is a perspective view of a collet base.

FIG. 5 is a cross-sectional view of the collet base of FIG. 4 taken along line V-V.

FIG. 6 is a perspective view of a collet.

FIG. 7 is a side view of the collet of FIG. 6.

FIG. 8 is a perspective view of a collet handle.

FIG. 9 is a cross-sectional view of the collet handle of FIG. 8 taken along line IX-IX.

FIG. 10 is a top view of the collet handle of FIG. 8.

FIG. 11 is a bottom view of the collet handle of FIG. 8.

FIG. 12 is a left side view of the collet handle of FIG. 8.

FIG. 13 is a right side view of the collet handle of FIG. 8.

FIG. 14 is rear view of the collet handle of FIG. 8.

FIG. 15 is a front view of the collet handle of FIG. 8.

FIG. 16 is a perspective view of a second example of an extension pole including a collet lock in accordance with the disclosure.

FIG. 17 is an exploded view of the extension pole of FIG. 16.

FIG. 18 is a cross-sectional view of the extension pole of FIG. 16 taken along line XVIII-XVIII.

FIG. 18A is an enlarged view of the rear end of the extension pole as shown in FIG. 17.

FIG. 19 is a perspective view of a tube stop base.

FIG. 20 is a cross-sectional view of the tube stop base of FIG. 19 taken along line XX-XX.

FIG. 21 is a perspective view of a tube stop seal.

FIG. 22 is a perspective view of a third example of an extension pole including a collet lock in accordance with the disclosure.

FIG. 23 is an exploded view of the extension pole of FIG. 22.

FIG. 24 is a perspective view of a fourth example of an extension pole including a collet lock in accordance with the disclosure.

FIG. 25 is a perspective view of a second example of a collet handle.

FIG. 26 is a top view of the collet handle of FIG. 25.

FIG. 27 is a bottom view of the collet handle of FIG. 25.

FIG. 28 is a left side view of the collet handle of FIG. 25.

FIG. 29 is a right side view of the collet handle of FIG. 25.

FIG. 30 is front view of the collet handle of FIG. 25.

FIG. 31 is a back view of the collet handle of FIG. 25.

FIG. 32 is a top view of a third example of a collet handle.

FIG. 33 is an end view of the collet handle of FIG. 32.

FIG. 34 is a top view of a fourth example of a collet handle.

FIG. 35 is an end view of the collet handle of FIG. 34.

FIG. 36 is a top view of a fifth example of a collet handle.

FIG. 37 is a cross-sectional view of the collet handle of FIG. 36 taken along line XXXVII-XXXVII.

FIG. 38 is a top view of a sixth example of a collet handle.

FIG. 39 is a cross-sectional view of the collet handle of FIG. 38 taken along line XXXIX-XXXIX.

While the disclosure is susceptible to various modifications and alternative constructions, certain illustrative embodiments thereof have been shown in the drawings and will be described below in further detail. It should be understood, however, that there is no intention to limit the disclosure to the specific forms disclosed, but on the contrary, the intention is to cover all modifications, alternative constructions, and equivalents falling within the spirit and scope of the invention as defined by the appended claims.

### DETAILED DESCRIPTION

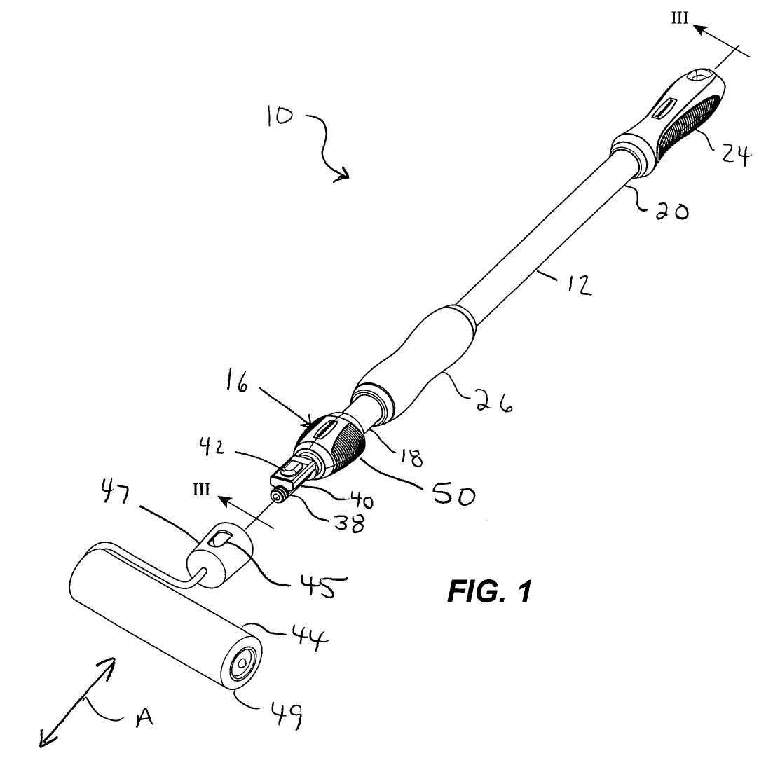

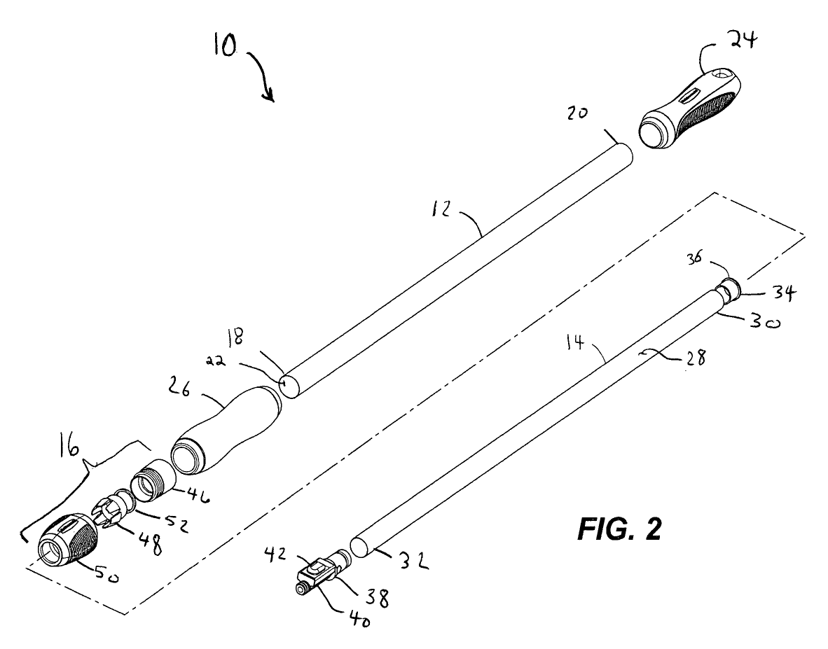

Referring now to the drawings, and specifically to FIGS. 1-3, an extension pole 10 is depicted. The extension pole 10 includes an outer tube 12, an inner tube 14 slidable within the outer tube 12, and a collet lock assembly 16 that selectively locks the inner tube 14 relative to the outer tube 12. A longitudinal axis A extends along the length of the extension pole 10. In this example, the outer tube 12 and inner tube 14 both have circular cross sections, but both tubes may have cross sections of other shapes.

The outer tube 12 has a front end 18, a rear end 20, and an inner surface 22. A rear grip 24 is disposed on the rear end 20 and a front grip 26 is disposed at the front end 18. While the rear grip 24 is disposed completely over the rear end 20, a portion of the front end 18 of the outer tube 12 extends forward of the front grip 26. The front and rear grips 24, 26 can be made from a soft material such as a thermoplastic elastomer and can be ergonomically constructed for a comfortable grip. The rear grip 24 seals against the rear end 20 of the outer tube 12 such that contaminants generally cannot enter or exit the rear end 20 of the outer tube 12. Typically, the rear grip 24 can be removed for maintenance and cleaning purposes, but the grip 24 may also be permanently adhered to the outer tube 12.

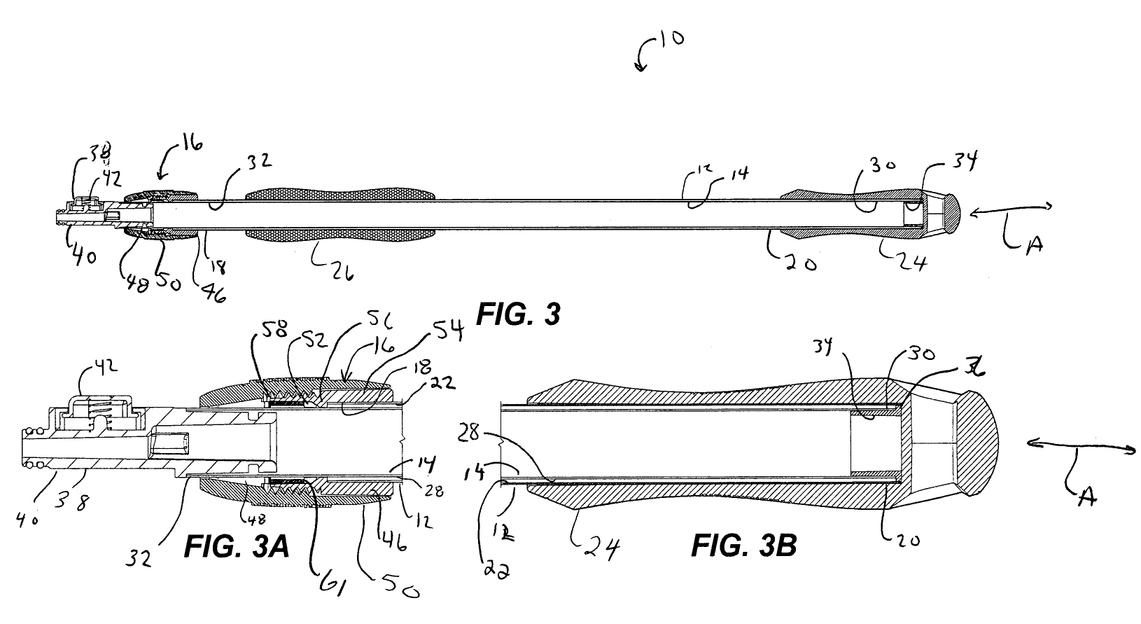

The inner tube 14 is disposed inside the outer tube 12 and is slidable within the outer tube 12 generally along the longitudinal axis A. The inner tube 14 has an outer surface 28 and also has a rear end 30 and a front end 32. A tube stop 34 is disposed on the rear end 30 of the inner tube 14 (see FIG. 3B). The tube stop 34 is a generally cylindrical member with a flange 36 extending radially outward at one end. The tube stop 34 extends slightly back from the rear end 30 of the inner tube 14 and the flange 36 extends radially outward of the outer surface 28 of the inner tube 14. The flange 36 is used to stop the inner tube 14 from sliding out of the outer tube 12, as will be described later. The flange 36 of the tube stop 34 generally has an outer diameter that is slightly less than the inner diameter of the outer tube 12 to allow the inner tube 14 to slide within the outer tube 12 and also to support the inner tube 14 within the outer tube 12.

A tip 38 can be disposed in the front end 32 of the inner tube 14. The tip 38 comprises a plug 40 and a depressible, resiliently biased button 42, which in its normal, biased position extends upwards from the plug top surface. A tool 44 can be snapped onto the plug 40 such that the button 42 of the tip 38 extends through an aperture 45 in a base 47 of the tool 44. Of course, tips having other structures can also be used to fasten a tool to the front end 32 of the inner tube 14. For example, a tip may have a threaded plug, a threaded hole, or the like. The tip 38 can be fastened to the inner tube 14 in any way known, including bonding, an interference fit, a combination of the two, or the like. Alternatively, the tool 44 could be directly fastened to the inner tube 14. Although the tool 44 as shown includes a paint roller 49, the tool 44 may include any suitable paint or liquid applicator such as a paint pad or a paint brush. Alternatively, the paint applicator 49 may be replaced with a cleaning tool such as a squeegee or a mop.

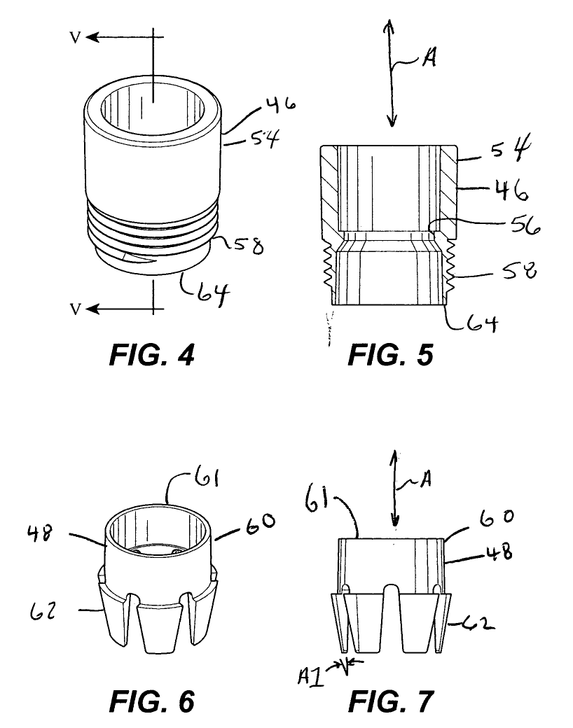

The collet lock assembly 16 is disposed on the front end 18 of the outer tube 12 and selectively locks and releases the inner tube 14 relative to the outer tube 12. The collet lock assembly 16 includes a collet base 46, a collet 48, a collet handle 50, and a collet seal 52. Referring now to FIGS. 4 and 5, the collet base 46 is generally cylindrical with a cap section 54, a neck section 56, and a threaded section 58. The neck section 56 has a smaller inner diameter than the inner diameter of the cap section 54. The cap section 54 is disposed over the front end 18 of the outer tube 12 such that the neck section 56 abuts the front end 18 of the outer tube 12 (see FIG. 3A). The cap section 54 can be secured to the outer tube 12 by an interference fit, an adhesive bonding agent or other known methods. The neck section 56 has an inner diameter slightly larger than the outer diameter of the inner tube 14 so that the inner tube 14 can slide through the collet base 46. With the collet base 46 disposed on the outer tube 12, the threaded section 58 extends outward away from the front end 18 of the outer tube 12.

Referring now to FIGS. 6 and 7, the collet 48 includes a cylindrical seat 60 and a series of teeth 62 extending away from the cylindrical seat 60. The teeth 62 are ramped such that the thickest part of each tooth 62 is adjacent to the cylindrical seat 60. In this example, the teeth 62 are at an angle A1 relative to the longitudinal axis A at approximately 10°, but other angles can obviously be used. A collet seal 52 can be disposed about the cylindrical seat 60 and abutting the teeth 62. The cylindrical seat 60 is disposed within the threaded section 58 of the collet base 46 with the collet seal 52 abutting a front end 64 of the threaded section 58 and the end 61 of the cylindrical seat 60 adjacent the neck section 56 of the collet base 46. Of course, the collet 48 can be any conventional collet. Further, the collet 48 can be integral with the collet base 46.

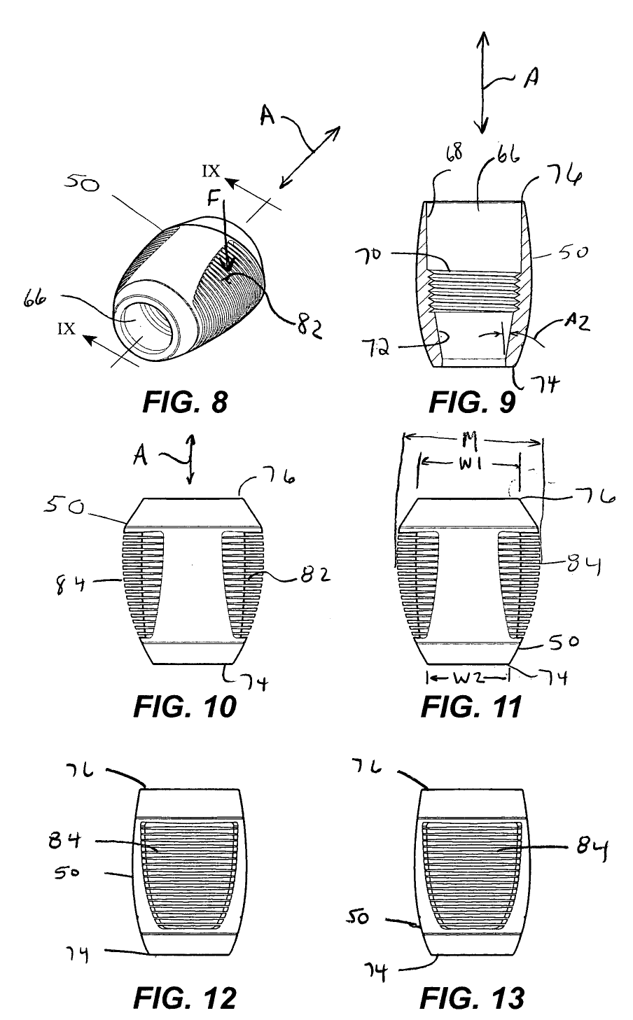

Referring to FIGS. 8-15, the collet handle 50 has an internal passage 66 with a cylindrical section 68, a threaded section 70, and a conical section 72. The internal passage 66 extends generally along the longitudinal axis A. The cylindrical section 68 is disposed over the cap section 54 of the collet base 46 such that the threaded section 70 of the collet handle 50 can engage the threaded section 58 of the collet base 46. The conical section 72 of the collet handle 50 is disposed over and engages the teeth 62 of the collet 48. In this example, the conical section 72 has an angle A2 of about 18° relative to the longitudinal axis A, but other angles can be used.

In use, rotation of the collet handle 50 relative to the collet base 46 selectively locks and releases the inner tube 14 relative to the outer tube 12. First, the user moves the inner tube 14 relative to the outer tube 12 such that the extension pole 10 has the desired overall length. When the collet handle 50 is rotated in a first direction, the collet handle 50 is pulled backwards toward the rear end 20 of the outer tube 12 by the interaction of the threaded section 70 of the collet handle 50 and the threaded section 58 of the collet base 46 (i.e. the same effect as turning a screw). As the collet handle 50 moves backward, the conical portion 72 of the collet handle 50 increasingly engages the ramped teeth 62 of the collet 48, forcing the teeth 62 inward toward the longitudinal axis A. The teeth 62 increasingly are forced onto the outer surface 28 of the inner tube 14 and ultimately lock the inner tube 14 in place relative to the outer tube 12 due to the high friction forces. To release the inner tube 14 relative to the outer tube 12, the collet handle 50 is rotated in the opposite direction, thereby moving the collet handle 50 toward the front end 32 of the inner tube 14 and allowing the teeth 62 to move radially outward from the longitudinal axis A so as to release the inner tube 14 such that it can slidably move relative to the outer tube 12.

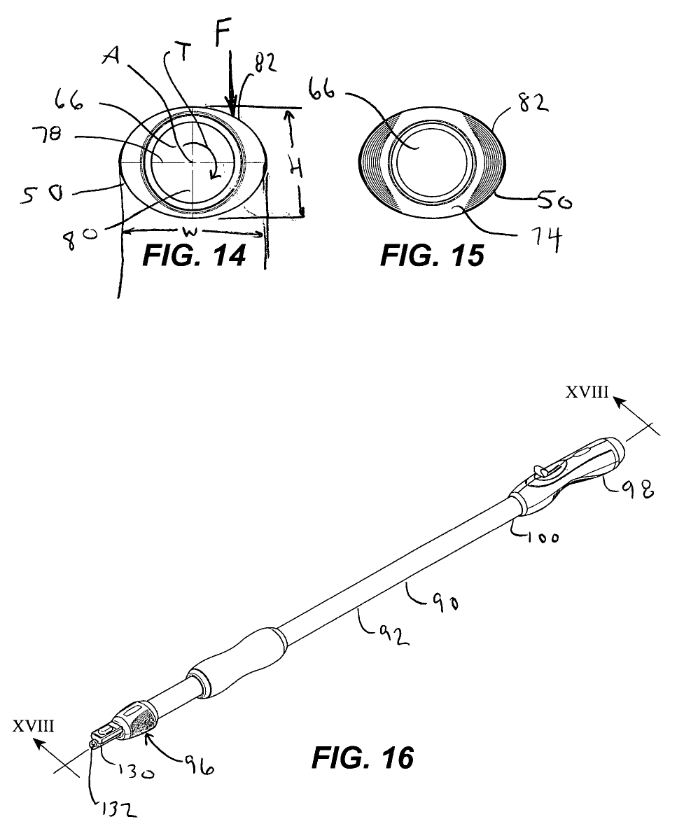

The collet handle 50 has a front end 74 and a rear end 76 and includes features that allow a user to turn the collet handle 50 with minimal exertion, even in wet environments. Referring specifically to FIG. 14, the collet handle 50 has a major axis 78 perpendicular to the longitudinal axis A and a minor axis 80 perpendicular to the major axis 78. The longitudinal axis A extends into the paper at the intersection of the major axis 78 and the minor axis 80. The width W of the collet handle is defined as the length of the collet handle along the major axis 78. The height H of the collet handle is defined as the length of the collet handle 50 along the minor axis 80. In this example, the width W of the collet handle 50 is longer than the height H of the collet handle 50 along a substantial portion (greater than about 50%) of the collet handle 50. Because the width W of the collet handle 50 is generally longer than the height H (as described above), the collet handle 50 is much easier for a user to turn. In another aspect, the collet handle 50 includes a surface 82 that extends generally in the direction of the major axis 78 such that a torque T can be applied to the collet handle 50 about the longitudinal axis A by applying a force F to the surface 82 perpendicular to the major axis 78 in the direction of the minor axis 80. In a further aspect, the collet handle 50 has an assymetrical shape. More specifically, the collet handle 50 does not have rotational symmetry about the longitudinal axis A.

In this example, in a plane taken perpendicular to the longitudinal axis A, the collet handle 50 generally has a cross-sectional shape of an oval or ellipsoid. Further, the width W of the collet handle increases as the collet handle proceeds away from the front end 74 until it reaches a maximum width M, then decreases as the collet handle 50 proceeds to the rear end 76. Referring specifically to FIG. 11, in other words, the collet handle 50 has a front width W1 at the front end 74, and a rear width W2 at the rear end 76 and a maximum width M between the front end 74 and the rear end 76. The collet handle 50 also includes a series of flaps 84 that extend in parallel outward in the direction of the major axis 78. The flaps 84 allow for easier compression of the collet handle 50 when grasped by the user, and also allow for any moisture on the collet handle 50 to drain in between the flaps 84 and off the outer surface of the collet handle 50.

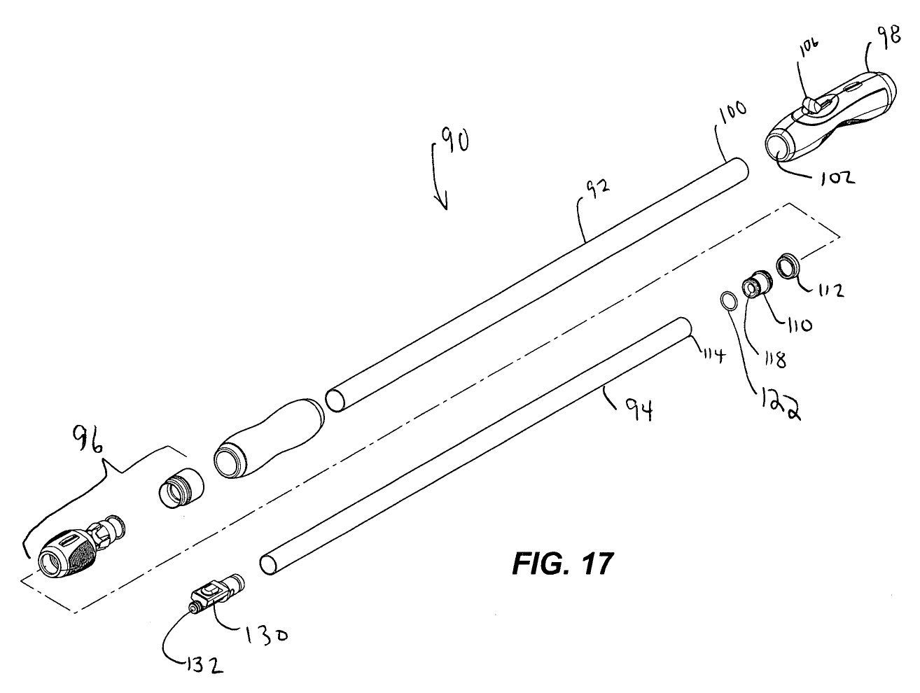

Referring now to FIGS. 16-18, a second example of an extension pole 90 is shown. The second extension pole 90 is different from the first extension pole 10 in that it includes features that allow for paint or another liquid to flow through the inside of the extension pole 90 to a tool (not shown) for applying a liquid to a surface such as a brush head or a paint applicator attached at the front end, thereby automatically supplying paint to the tool. The extension pole 90 includes an outer tube 92, an inner tube 94, and a collet lock assembly 96 that is structurally the same as and functions the same as the collet lock assembly 16 in the first extension pole 10.

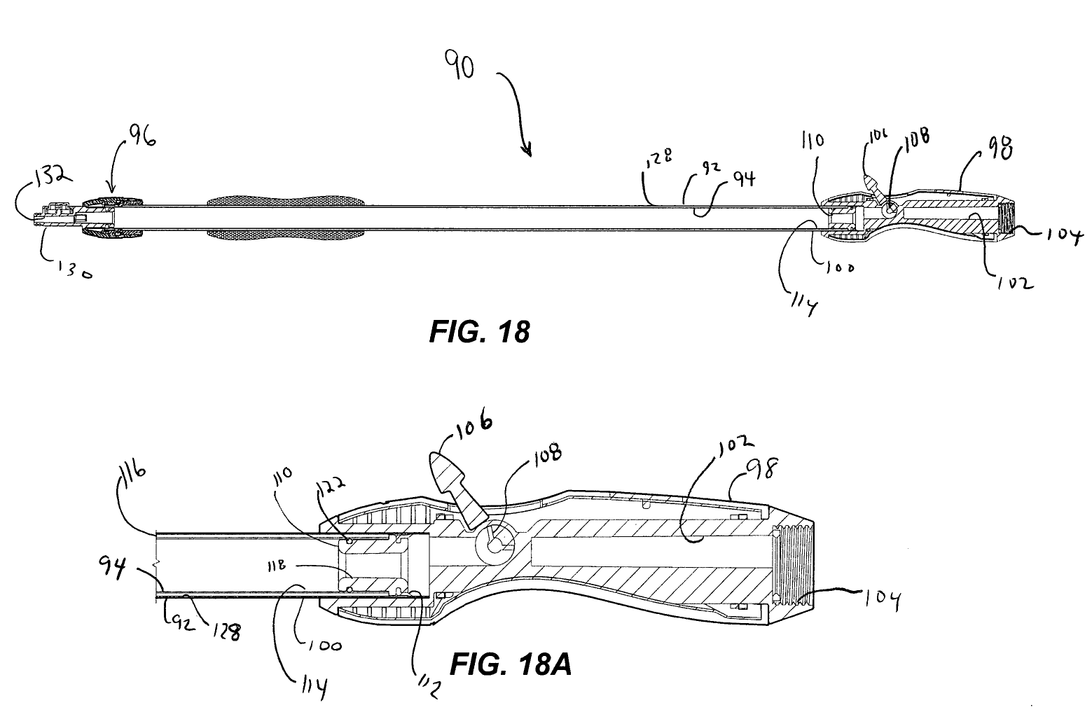

A rear grip 98 is disposed on a rear end 100 of the outer tube 92 (See FIG. 18A). The rear grip 98 includes an inner channel 102 extending the length of the rear grip 98. The inner channel 102 includes an internally threaded section 104 at the rear end of the rear grip 98 for connection to a liquid source. A toggle switch 106 is connected to a valve 108 disposed in the inner channel 102 to selectively allow liquid to flow through the inner channel 102 of the rear grip 98 and into the outer tube 92.

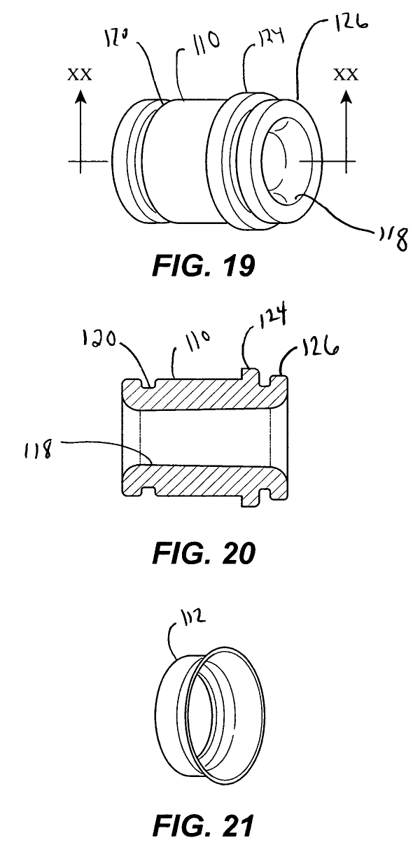

Referring now to FIGS. 19 and 20, a tube stop base 110 and a tube stop seal 112 are disposed in a rear end 114 of the inner tube 94 such that the interior of the inner tube 94 is sealed to the interior of the outer tube 92, and no liquid can escape into a gap 116 existing between the inner tube 94 and the outer tube 92 (see FIG. 18a). The tube stop base 110 is generally cylindrical with an internal passage 118 to allow paint to flow through it. The tube stop base 110 includes a recess 120 on its front end in which a gasket 122 is disposed to seal the tube stop base 110 relative to the inner tube 94. The tube stop base 110 includes a flange 124 that extends radially outward and bears against the rear end 114 of the inner tube 94. The flange 124 prevents the inner tube 94 from sliding out of the outer tube 92. A connector 126 extends to the rear of the flange 124 for connection of the tube stop seal.

Referring now to FIG. 21, the tube stop seal 112 is disposed over the connector 126 of the tube stop base 110 and flexibly extends radially outward, pressing against the inner surface 128 of the outer tube 92. The tube stop seal 112 prevents paint or other liquid from entering the gap 116 between the inner tube 94 and the outer tube 92, as previously described.

A tip 130 similar to tip 38 includes an inner channel 132 as well such that paint (or another liquid) can be forced through the internal channel 102 of the rear grip 98, through the outer tube 92, the inner tube 94, and the tip 130 and into a tool such as a paint applicator (not shown). The paint is supplied to the paint applicator in a controlled manner and the user is not required to apply paint to the paint applicator prior to applying paint to the surface to be painted.

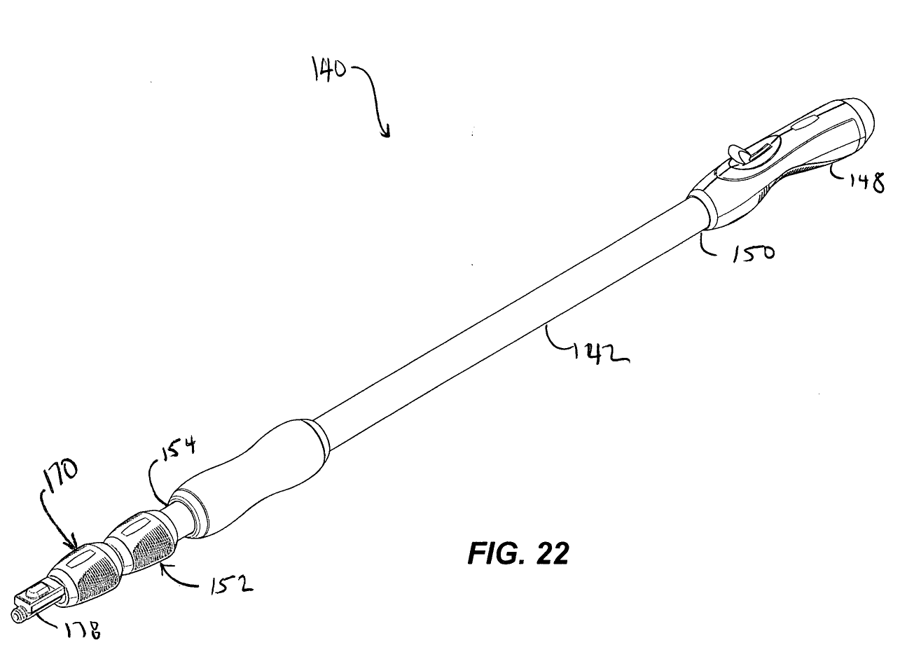

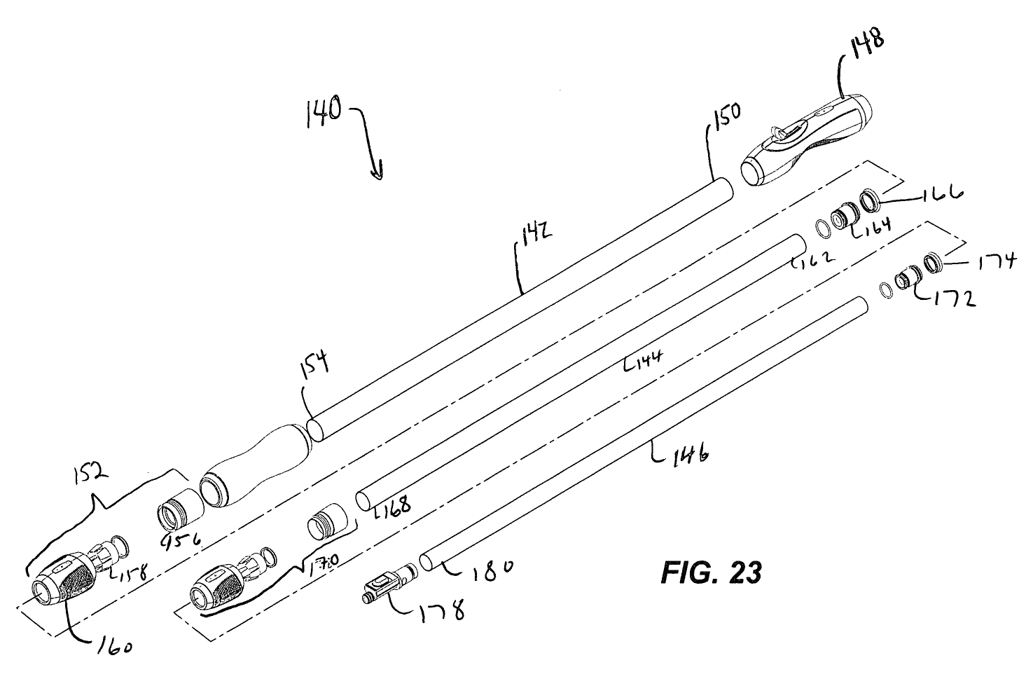

Referring now to FIGS. 22-23, a third example of an extension pole 140 is shown. The third extension pole 140 is generally similar to the second extension pole 90 except that it includes a total of three tubes so that the extension pole 140 can be extended a greater length. The third extension pole 140 includes an outer tube 142, a middle tube 144 slidably disposed in the outer tube 142, and an inner tube 146 slidably disposed in the middle tube 144. A rear grip 148 is disposed on a rear end 150 of the outer tube 142. In this example, the rear grip 148 has the same construction as the rear grip 98 of the second example so that liquid can flow through it.

A first collet lock assembly 152 is disposed on a front end 154 of the outer tube 142. This collet lock assembly 152 can be substantially the same as the collet lock assembly 16 and can include a first collet base 156, a first collet 158, and a first collet handle 160. Disposed on a rear end 162 of the middle tube 144 is a tube stop base 164 and a tube stop seal 166, as in the extension pole 90.

Up to this point, the third example of an extension pole 140 is substantially the same as the extension pole 90. However, a tip assembly is not disposed on the front end 168 of the middle tube 144. Instead, a second collet lock assembly 170 is disposed on the front end 168 of the middle tube 144. The second collet lock assembly 170 can be the same as the first collet lock assembly 152, except the constituent parts are smaller so as to fit over the smaller middle tube 144 and interact with the smaller yet inner tube 146. Likewise, a second tube stop base 172 and a second tube stop seal 174 are disposed on a rear end 176 of the inner tube 146. Thus, a user can selectively lock and release the middle tube 144 relative to the inner tube 146 to extend and retract the inner tube 146 relative to the middle tube 144. Similarly, the user can also selectively lock and release the outer tube 142 relative to middle tube 144 to extend and retract the middle and inner tubes 144, 146 relative to the outer tube 142. As in the previous examples, a tip 178 is disposed on a front end 180 of the inner tube 146.

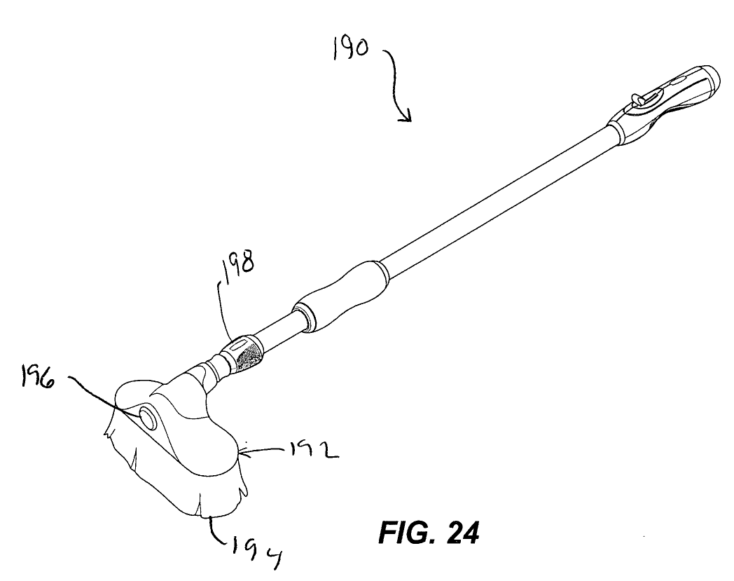

Referring now to FIG. 24, another example of an extension pole 190 is depicted. The extension pole 190 can have the same construction as that depicted in the second example. However, instead of a tip disposed on the extension pole 190, a brush head 192 with a combination brush 194 and nozzle 196 is disposed on extension pole 190. Soapy water can be either directed through the nozzle 196 for a directed water flow, or through the brush 194. The brush head 192 can be extended and retracted by rotation of a collet handle 198 as in the previous examples.

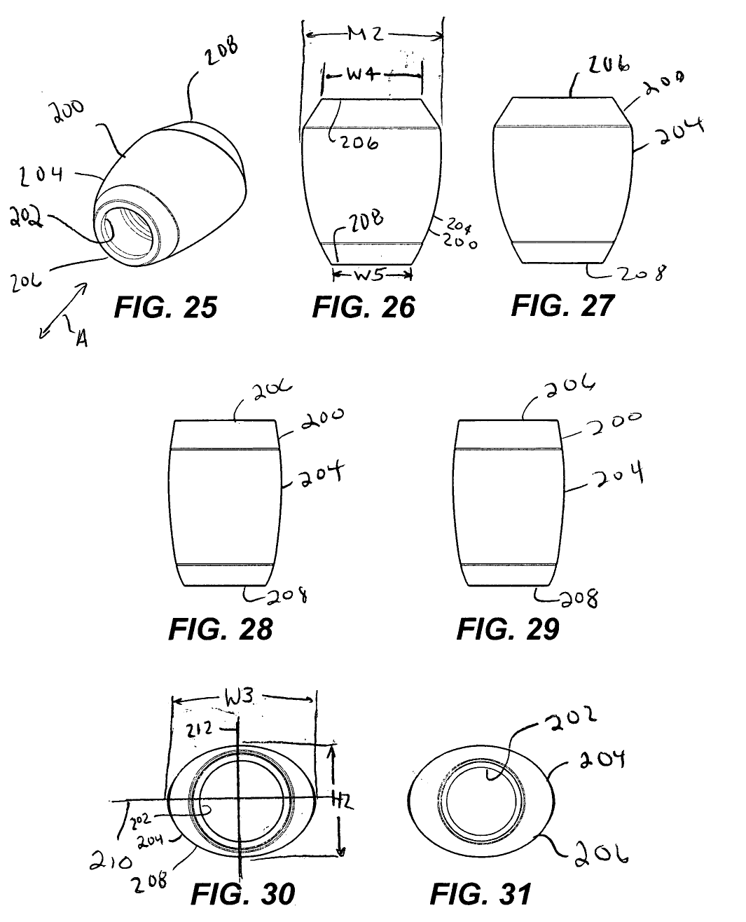

Referring now to FIGS. 25-31, a second example of a collet handle 200 is depicted. This collet handle 200 is generally similar in size and shape to the collet handle 50 depicted in FIG. 8. The collet handle 200 includes an inner channel 202 along which a longitudinal axis A can extend. However, the collet handle 200 does not include a series of flaps extending outward. Instead, the collet handle 200 has an outer surface 204 that is continuous.

The collet handle 200 has a front end 206 and a rear end 208. The collet handle 200 has a major axis 210 perpendicular to the longitudinal axis A and a minor axis 212 perpendicular to the major axis 210. The width W3 of the collet handle 200 along the major axis 210 is longer than the height H3 of the collet handle 200 along the minor axis 212. In this example, the width W3 is longer than the height H3 along the entire length of the collet handle 200, and again, improves the ability of the user to turn the collet handle 200. The collet handle 200 generally has a cross-sectional shape of an oval or ellipsoid and the width W3 of the collet handle 200 increases as the collet handle 200 proceeds away from the front end 206 until it reaches a maximum width M2, then decreases as the collet handle 200 proceeds to the rear end 208. In other words, the collet handle 200 has a front width W4 at the front end 206, a rear width W5 at the rear end 208, and a maximum width M2 between the front end 206 and the rear end 208.

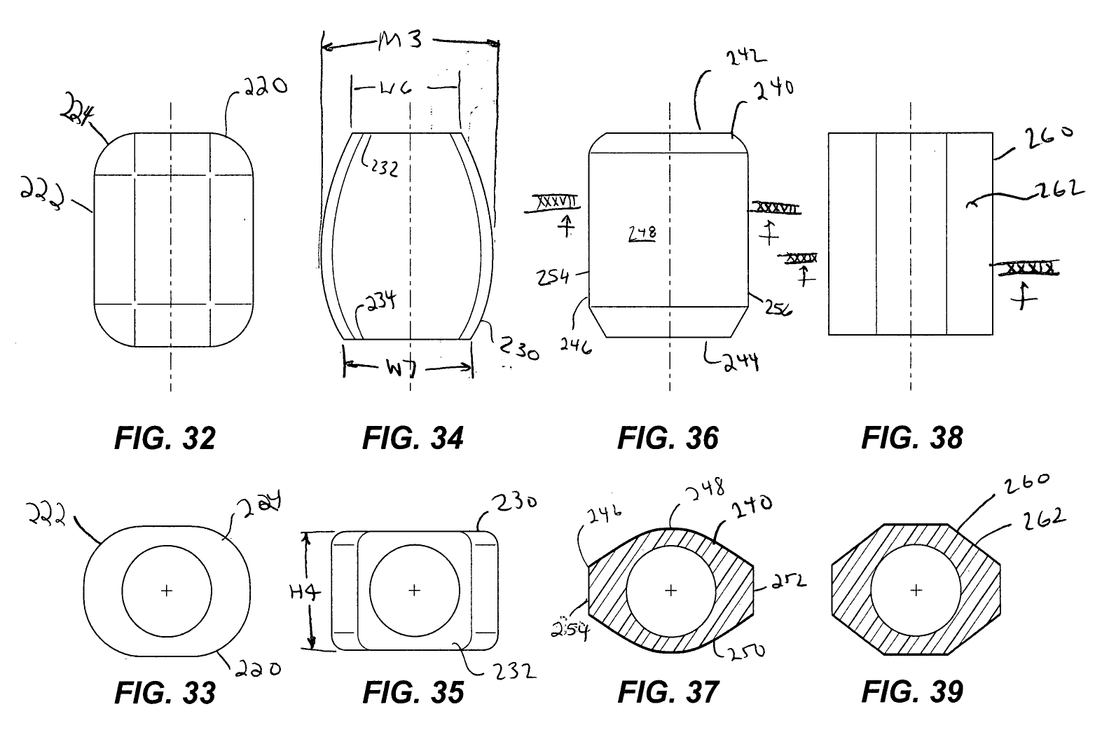

FIGS. 32-39 disclose further alternate examples of collet handles. Each of these examples have an internal passage along a longitudinal axis similar to the internal passage 66. Each function similarly by engaging a collet to lock an inner tube relative to an outer tube. In each of these examples, the width of the collet handle is greater than the height along at least a portion of the longitudinal axis. In other words, in each example, a surface extends outward generally in the direction of the major axis such that a torque can be applied to the collet handle by applying a force to the surface perpendicular to the major axis in the direction of the minor axis.

FIGS. 32 and 33 disclose a third example of a collet handle 220. The collet handle 220 in this example is generally in the shape of a parallelepiped. Here, all the edges 222 and corners 224 are radiused (or curved) to provide a smooth and comfortable grip. FIGS. 34 and 35 disclose a fourth example of a collet handle 230. In this example, the height H4 is constant along the length of the collet handle 230. A front width W6 at a front end 232 and a rear width W7 at a rear end 234 are shorter than a maximum width M3 between the front end 232 and the rear end 234.

FIGS. 36 and 37 disclose a fifth example of a collet handle 240. In this example, the collet handle 240 has a front end 242 and a rear end 244 with edges 246. The collet handle 240 includes four surfaces along its length, seen especially in the cross-sectional view of FIG. 36. First and second surfaces 248, 250 are opposing surfaces that generally take the shape of opposing arcs. Third and fourth surfaces 252, 254 are opposing parallel surfaces. The edges 246 can be radiused at the front end 242 and the rear end 244. FIGS. 38 and 39 disclose a sixth example of a collet handle 260. In this example, the collet handle 260 includes eight surfaces 262 along its length, such that the collet handle 260 takes the shape of an octagon in the cross-sectional view of FIG. 38.

The foregoing description is not intended to limit the scope of the invention to the precise form disclosed. It is contemplated that various changes and modifications may be made by those skilled in the art without departing from the spirit and scope of the invention.

What is claimed is:

1. A rotatable handle for use with a collet in a wet environment, comprising:
a body with an internal passage extending therethrough, the internal passage being at least partially threaded, the body being disposable on a threaded collet base, whereby upon rotation of the body relative to the threaded collet base, the body can selectively engage a collet such that the collet engages a tube, thereby selectively locating the tube;
wherein the body has a longitudinal axis along the passage, a major axis perpendicular to the longitudinal axis, and a minor axis perpendicular to the major axis, wherein the body has a first length along the major axis and a second length along the minor axis, and the first length is longer than the second length.

2. The handle of claim 1, wherein the internal passage of the body comprises a cylindrical section, a threaded section, and a conical section, wherein the conical section is engageable with the collet.

3. The handle of claim 1, wherein a cross section of the body taken perpendicular to the longitudinal axis has the shape of an oval or an ellipsoid.

4. The handle of claim 1, the body further comprising a front end and a rear end, and having a front width at the front end, a rear width at the rear end, and a maximum width between the front end and the rear end.

5. The handle of claim 1, the body further comprising a series of flaps extending out from the body.

6. The handle of claim 1, the body further comprising a surface extending generally in the direction of the major axis such that a torque can be applied to the body by applying a force to the surface perpendicular to the major axis in the direction of the minor axis.

7. The handle of claim 1, wherein the body is in the shape of a parallelepiped with radiused corners.

8. The handle of claim 1, wherein a cross section of the body taken perpendicular to the longitudinal axis has the shape of an octagon.

9. The handle of claim 1, wherein a cross section of the body taken perpendicular to the longitudinal axis includes opposing arced surfaces and opposing flat surfaces.

10. An extension pole, comprising:
an outer tube having a rear end, a front end, and a longitudinal axis;
a collet base disposed on the front end of the outer tube and being at least partially threaded;
a collet adjacent the threaded collet base;
an inner tube with a front end and a rear end disposed at least partially within the outer tube and slidable relative to the outer tube along the longitudinal axis through the collet base and the collet; and
a handle with an internal passage extending therethrough, the internal passage being at least partially threaded, the handle being disposed on the collet base, whereby upon rotation of the handle relative to the collet base, the handle selectively engages the collet such that the collet engages the inner tube, thereby selectively locating the outer tube relative to the inner tube;
wherein the handle has a major axis perpendicular to the longitudinal axis and a minor axis perpendicular to the major axis, wherein the handle has a first length along the major axis and a second length along the minor axis, and the first length is longer than the second length.

11. The extension pole of claim 10, the passage of the handle comprising a cylindrical section, a threaded section, and a conical section, wherein the conical section is engages the collet.

12. The extension pole of claim 10, wherein a cross section of the handle taken perpendicular to the longitudinal axis is generally in the shape of an oval or an ellipsoid.

13. The extension pole of claim 10, the handle further comprising a front end and a rear end, and having a front width at the front end, a rear width at the rear end, and a maximum width between the front end and the rear end.

14. The extension pole of claim 10, the handle further comprising a series of flaps extending out from the handle.

15. The extension pole of claim 10, the handle further comprising a surface extending generally in the direction of the major axis such that a torque can be applied to the handle by applying a force to the surface perpendicular to the major axis in the direction of the minor axis.

16. The extension pole of claim 10, further comprising a brush disposed on the front end of the inner tube.

17. The extension pole of claim 10, wherein the collet includes a cylindrical seat and a set of ramped teeth extending from the cylindrical seat, the internal passage of the handle includes a conical section, and the conical section of the handle engages the ramped teeth.

18. The extension pole of claim 10, further comprising an assembly tip disposed in inner tube and configured to releasably retain a tool.

19. The extension pole of claim 10, further comprising a rear handle disposed on the rear end of the outer tube, wherein rear handle includes an inner passage to allow liquid to flow therethrough.

20. The extension pole of claim 10, wherein the collet base includes a neck section, the extension pole further comprising a tube stop disposed in the rear end of the inner tube, the tube stop including a flanged section with an outer diameter greater than an inner diameter of the neck section such that the neck section maintains the inner tube at least partially inside the outer tube.

21. The extension pole of claim 10, further comprising a tube stop base disposed in the rear end of the inner tube and a tube stop seal disposed on the end of the tube stop base, wherein the tube stop seal restricts liquid from entering a gap between the inner tube and the outer tube.
